(19) United States
(12) Patent Application Publication
(10) Pub. No.: US 2006/0201548 A1
(43) Pub. Date: Sep. 14, 2006

(54) Sleeve and piston valve with emptying device

(76) Inventor: Rufus M. Holloway JR., Orlando, FL (US)

Correspondence Address: B. K. NIYOGI., 78 CYPRESS STREET., MILLBURN., NJ, 07041, US

(21) Appl. No.: 11/368,571

(22) Filed: Mar. 6, 2006

Related U.S. Application Data
(60) Provisional application No. 60/659,779, filed on Mar. 9, 2005.

(51) Int. Cl. G05D 11/00

(52) U.S. Cl. 137/119.03

(57) ABSTRACT

The present invention relates to a hydraulic valve arranged for connecting to a water supply source, constituted by three separate co-axially disposed and spaced apart telescopic cylindrical members. The outer cylinder regulates water flow, the middle cylinder has openings or windows and the inner cylinder has a bottom, with the inner cylinder interconnected with the outer cylinder having a hoisting means constituted by a cable and pulley system. Alternatively the valve may operate with the inner cylinder as the piston which closes the valve. In that case the outer cylinder acts as a water weight to raise the piston and open the valve.

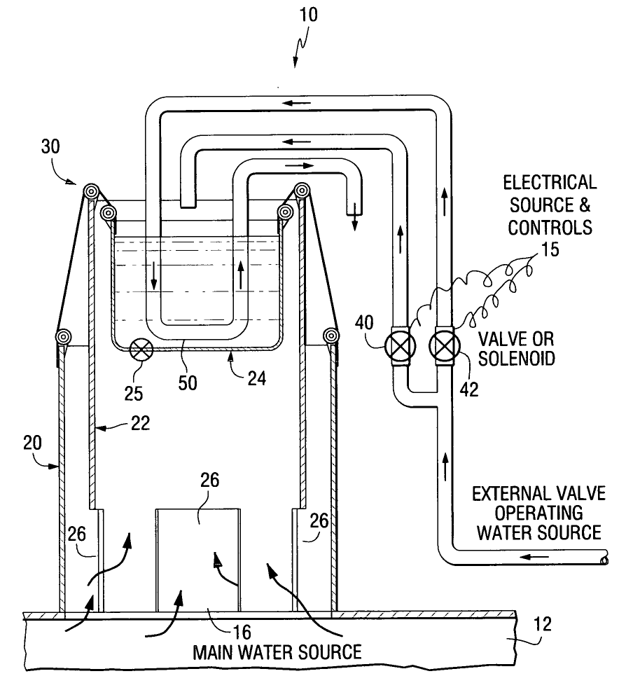

### BACKGROUND OF THE INVENTION

The present invention relates to a hydraulic valve adapted to be in direct connection with a water flow supply source so as to constitute a hydraulic valve system.

It is well known to regulate and control water distribution specifically in rural areas by using hydraulic valves, sluices, or the like.

One of the problems encountered by such an arrangement is that hydraulic valves are fairly complex and also expensive requiring electrical power and hoisting gear actuated by electrical motor drives and gear arrangements, for remote and local operation depending on the location of the valve.

### OBJECTS OF THE INVENTION

An object of the present invention is to provide a simple and also inexpensive hydraulic valve with essentially co-axially disposed and spaced apart cylindrical members, so as to regulate water flow.

A further object of the present invention in to interconnect the hydraulic valve of the present invention to a water supply source, such as a pipe or a conduit to constitute a hydraulic valve system, and operated with low pressure water pressure and/or solar energy.

A still further object of this valve is to regulate movement of large volumes of water at low or medium pressure, using solar energy and water pressure as the energy sources for operation. Thus, the valve can be used in rural areas with no electricity supply, so long as water under low pressure is available.

Advantageously, water supply could be a water tank capturing water at a higher elevation than that of the valve so that the valve could operate: for example, using a very low pressure pump that requires only a limited amount of electrical energy. The water could be stored and then released in larger quantities to operate the valve using solar energy when necessary. The valve can be operated by remote control, using only low voltage electrical current, easily stored by a solar energy panel in a battery bank.

An additional object is that the valve can be installed in different sizes, suitable and preferably up to at least 60 inches in diameter, and could be used where large valves are extremely expensive and operate on significant amounts of electrical current and special operating devices.

### SUMMARY OF THE INVENTION

The present invention comprises a hydraulic valve comprising a plurality of spaced apart co-axially disposed cylinders adapted for telescopic movement, so that an outer cylinder is adapted to regulate water flow, a middle cylinder formed with openings or windows for water flow internally or externally, and an inner cylinder provided with a bottom and interconnected to the outer cylinder by a hoisting means, constituted by a cable and pulley system.

Advantageously, the present invention includes a hydraulic valve system, adapted for operation with low pressure water supply, comprising a water supply source constituted by a water supply pipe, a hydraulic valve arrangement having a plurality of co-axially disposed tubular members of differing diameters and spaced apart capable of telescopic movement between the tubular members, and a lifting member connected to an outermost of the tubular members as so to regulate water flow through the hydraulic valve arrangement by telescopic movement of the tubular members.

The essential and inventive purpose of this hydraulic valve and the arrangement of the hydraulic valve system is to allow the movement and flow of large volumes of water at low or medium pressure using solar energy as the energy source and water pressures as an alternative energy source for the operation and actuation of the hydraulic valve.

The present invention permits the operation of the valve and the system in predominantly rural areas where there are no electrical energy supplies. In the alternative arrangement water under low pressure is available. This water supply source could be a water tank capturing water at a higher elevation than that of the valve to enable the valve to operate. The water could be stored using only solar energy and subsequently the water is released in quantities so as to actuate the valve as required.

Conveniently, the water may be stored and released only in predetermined quantities, thus ensuring economic use of the hydraulic valve as well as the entire system. The valve can be operated from a remote distance, using only low voltage electrical current, easily stored by a solar energy panel in a battery bank.

It will be appreciated that the valve can be installed in different sizes, preferably up to at least 60 inches in diameter.

### BRIEF DESCRIPTION OF THE DRAWING

The invention will now be described, by way of example, with reference to the only single drawing of the invention in elevation form.

### DESCRIPTION OF THE INVENTION

The invention will now be described, by way of example, with reference to the single figure accompanying drawing in which: the preferred example of a valve (10) comprising a plurality of spaced apart and co-axially disposed cylinders, specifically three main cylinders (20, 22, 24) and arranged for the respective cylinders adapted for co-axial telescopic movement. An outer cylinder (20) is used to regulate water flow, a middle cylinder (22) provided with openings or windows (26) for water to flow internally or externally and also supports the other cylinder (20) and an inner cylinder (24) provided with a bottom (50) in the form of a piston so that it can retain water. The inner cylinder is connected to the outer cylinder by a hoisting mechanism (30) constituted by a cable pulley system, supported by the middle cylinder.

In operation, the inner cylinder (24) fills with water and weighs more than the outer cylinder, thus lifting the outer cylinder so that water can pass through in either direction through the openings or windows (26) of the middle cylinder externally or internally from a piping supply source (12) through the entry opening (16).

Suitably, the inventive and novel characteristics of the valve utilizes the hoisting mechanism (30) of the outer cylinder, with the use of water only from a separate low pressure source and a small amount of low voltage electrical energy, such as a 12 volt electrical energy to actuate and operate a pair of specifically adapted solenoids (40,42) attached to an external source. The system including the valve (10) uses the water source and supplies it to the inner cylinder (24) when a first solenoid (40) is opened on electrical command. After the inner cylinder is filled to a predetermined amount, either partially or fully, a sensor (not shown) closes the first solenoid (40) and the inner cylinder which now weighs more than the outer cylinder, enables water to flow internally or externally of the valving system.

The outer cylinder can be raised by a mechanical motor or lifting chain cable and pulley or even manually, not utilizing the inner cylinder arrangement as described.

The valve is adapted for closing by removing water from the inner cylinder, causing the weights to be lighter, thus allowing the outer cylinder to lower and to close the flow of water through the valve. The inner cylinder is interconnected by a small pump (not shown), drain valve or vacuum that results from a command to a second solenoid (42) or other energy source that opens a small water supply source and vacuums the water from the inner cylinder. The pump (not shown) could assist in the evacuation of the water from the inner cylinder. Suitably, a drainage provision could assist in the evacuation of the water from the inner cylinder.

Alternatively, a solenoid may be used to activate a drain valve for emptying the inner cylinder with the help of a small water supply source (25).

Conveniently, the operational process can be operated from either an electrical energy source, from solar energy, or battery banks. One suitable characteristic of the present invention is that the hydraulic valve system may be operable from a remote distance, and also can be programmed by a programmable logic controller and a co-operative computer (not shown.)

Advantageously, this rather novel and inventive hydraulic tubular valve and the hydraulic valve system has its essential applications in remote areas where there is a lack of electricity nor water supply under pressure may be available. The pressure of water necessary to operate the solenoid valves can be acquired by a very small pump using low voltage power feeding water into a tank (not shown) located well above the height of the valve so that the water pressure required to operate the solenoids will always be present.

It should be noted that the combination of the three cylinders each co-axially disposed and spaced apart is adapted to be telescopically slidable and can also be reversed. The inner cylinder (24) can act as a piston (50) to stop the waterflow through the valve (10) by positive downward pressure caused by the inner cylinder filling with water. The weight of the piston (50) when filled with water is greater than the pressure of the water flowing through the valve so that sealing the valve from water flow through it.

One of the advantages of this invention is the possibility of two applications that allow the valve to operate under different pressure conditions. For example, preferably when the valve operates in a low pressure system, the outer cylinder controls and regulates the water flow. However, when the high pressure conditions are present then the piston actuation may be preferable, since the piston can be weighted with more water to establish a large downward thrust which will turn off a higher pressure water flow. The inner cylinder can be raised and lowered by a motor and chain or rope arrangement or by manual lifting.

Suitably, this inventive and novel hydraulic valve including the valve system could be adapted for use anywhere large volumes of water under low or medium pressure requires movement and transfer such as in large flood control areas, aquatic farms, waste water plants, and large scale irrigation projects.

The present invention depicts the hydraulic valve (10) which is sealingly interconnected to a low pressure water supply source (12) by way of water flow through an entry (16).

In operation, the hydraulic valve (10) incorporating the hydraulic system (12), comprises the outer cylinder (20) connected to the inner cylinder (24) and utilizing a hoisting arrangement constituted by a pulley and cable mechanism (30). The hoisting mechanism (30) serves as a counterweight that raises the inner piston (50) allowing the valve to open. In this specific operation, the outer cylinder (20) could be used for water retaining eight which is filled or emptied assisted by the first solenoid (40) and the second solenoid (42). Alternatively, a vacuum pump, drain valve or conventional pump allows when the water filling it would lift the inner cylinder (24) and conversely when emptied would become lighter and allow the water filled inner piston (50) to sit well, thus stopping the flow of water through the valve.

It will be appreciated that the water supply source may be adapted to a predetermined pressure. Moreover, the inner cylinder may also be emptied or evacuated by a drainage system, constituted by a drain valve and/or assisted by a pump.

Suitably, the inner cylinder and the outer cylinder may be utilized by adapting balancing measured weights, and the flat bottom of the inner cylinder may be adapted to be operable as a piston.

1. A hydraulic valve system, adapted for operation with low pressure water supply, comprising a water supply source constituted by a water supply pipe, a hydraulic valve arrangement having a plurality of co-axially disposed tubular members of differing diameters and spaced apart capable of telescopic movement between the tubular members, and a lifting member constituted by any form of hoisting, connected to an outermost of the tubular members so as to regulate water flow through the hydraulic valve arrangement by telescopic movement of the tubular members.

2. A hydraulic valve system as claimed in claim 1, wherein the water supply co-operatively works with a solar energy panel for an electrical energy source.

3. A hydraulic valve system as claimed in claim 1, wherein the water supply source may be adapted to a predetermined pressure.

4. A hydraulic valve system as claimed in claim 1, wherein the hydraulic valve comprises three co-axially disposed, spaced apart cylinders of different diameters, with each cylinder adapted for telescopic movement within each other, and in which the middle cylinder is provided with openings in the form of window so that the water can flow through the telescopic valve system.

5. A hydraulic valve system as claimed in claim 4, wherein the middle cylinder is arranged for the water flow and also to provide support to the inner and outer cylinders.

6. A hydraulic valve system as claimed in claim 5, wherein the inner cylinder is provided with a bottom piece which can retain water and is interconnected to the outer sleeve by a hoisting means formed by a cable and a pulley system supported by the middle cylinder.

7. A hydraulic valve system as claimed in claim 6, wherein the hoisting means utilizes water or substantially similar liquid from an independent water supply source and also may be assisted by a low voltage electrical energy source.

8. A hydraulic valve system as claimed in claim 7, wherein the low voltage electrical source comprises an electrical power supply source to operate a pair of specifically arranged solenoids.

9. A hydraulic system as claimed in claim 7, wherein the independent water source supplies water to the inner cylinder at a predetermined electrical command.

10. A hydraulic system as claimed in claim 9, wherein water in the inner cylinder may be emptied with the assistance of a small pump, drain valve, or a vacuum created by predetermined electrical command.

11. A hydraulic valve system as claimed in claim 10, wherein the drain valve can be actuated for emptying the inner cylinder by predetermined electrical energy source.

12. A hydraulic valve system as claimed in claim 11, wherein the inner cylinder may be emptied by vacuum using a conventional electrical energy source or from a solar energy source.

13. A hydraulic valve system as claimed in claim 11, wherein the inner cylinder may be emptied by a drainage system, constituted by a drain valve, and/or assisted by a pump.

14. A hydraulic valve system as claimed in claim 11, wherein the energy source can be actuated from remote control operation and operable by programmable logic controller and a computer.

15. A hydraulic valve system as claimed in claim 1, wherein a combination of three separate co-axially disposed and spaced apart cylinders each adapted for telescopic movement within each other may be reversed in movement, with the inner cylinder operable as a piston to regulate water flow through the valve.

16. A hydraulic valve system as claimed in claim 15, wherein the outer cylinder and the inner cylinder could be adapted for counter-balancing purposes by any form of measurable weights.

17. A hydraulic valve system as claimed in claim 1, wherein the valve can be of different sizes, of up to about 60 inches.

18. A hydraulic valve comprising a plurality of spaced apart and co-axially disposed cylinders adapted for telescopic movement, so that an outer cylinder is adapted to regulate water flow, a middle cylinder formed with openings or windows for water flow internally or externally, and an inner cylinder provided with a bottom and interconnected to the outer cylinder by a lifting member constituted by any form of hoisting means.

19. A hydraulic valve as claimed in claim 18, wherein a flat bottom of the inner cylinder is adapted to be operable as a piston.

20. A hydraulic valve as claimed in claim 18, wherein the valve is interconnected by a conduit to a water supply source, to constitute a hydraulic valve system.

21. A hydraulic valve as claimed in claim 19, wherein the valve system is adapted to be operable by water pressure and assisted by any form of energy source such as solar energy or suitable electrical energy source.
